(19) United States
(12) Patent Application Publication
(10) Pub. No.: US 2017/0132338 A1
(43) Pub. Date: May 11, 2017

(54) HYDRAULIC DISTRIBUTION NETWORK MODELING

(71) Applicant: Osama S. Al Gahtani, Riyadh (SA)

(72) Inventor: Osama S. Al Gahtani, Riyadh (SA)

(21) Appl. No.: 15/347,927

(22) Filed: Nov. 10, 2016

Related U.S. Application Data
(60) Provisional application No. 62/253,259, filed on Nov. 10, 2015.

(51) Int. Cl. G06F 17/50; G06F 17/11; E03B 1/02; G06F 17/16

(52) U.S. Cl. CPC G06F 17/5009; G06F 17/16; G06F 17/11; E03B 1/02; G06F 2217/34; G06F 2217/16

(57) ABSTRACT

The embodiments described herein are directed to identifying insufficient pressure nodes in a water network for real-time online monitoring and overcoming demand reduction in both insufficient and deficient pressure nodes. In one embodiment, a computer-implemented method comprises executing an application to generate pressure head measurements associated with nodes in a water network based on data associated with the water network, determining one of the plurality of nodes having a pressure head measurement less than a minimum value, identifying a subset of the plurality of nodes at which a pressure head measurement is less than an elevation value, identifying a most negative pressure node from the subset, setting one of a plurality of node parameters associated with the most negative pressure node to zero pressure and zero demand, and setting a pipe parameter associated with a plurality of pipes connected to the most negative pressure node to zero flow.

### CROSS-REFERENCE TO RELATED APPLICATIONS

This application claims the benefit of U.S. Provisional Application No. 62/253,259, filed Nov. 10, 2015, the entire contents of which is hereby incorporated herein by reference.

### BACKGROUND

Hydraulic modeling can be performed through simulation using computing devices. In the field of water network modeling EPANET and EPANET2 are examples of water distribution system modeling software packages. EPANET and EPANET2 were developed by the United States Environmental Protection Agency's (EPA) Water Supply and Water Resources Division. EPANET and EPANET2 can be used simulate the flow of water in networks of pressurized pipes over extended periods of time.

In general, hydraulic modeling software can provide an environment for editing the form and characteristics of water networks of any size, running hydraulic and/or water quality simulations, and viewing the results in various formats. Hydraulic modeling software can also simulate how the demand for water can vary spatially over time within water network. The demand can be simulated to account for variable speed pumps, the head losses for bends and fittings, and other water network components and characteristics. Hydraulic modeling software can provide many different types of information, such as the volume of water flow in pipes, the water pressure in pipes and at nodes, the propagation of contaminants, water age, and other relevant factors.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawinhgs, like reference numerals designate corresponding parts throughout the several views.

FIG. 1 illustrates the hydraulic grade line (HGL) along the pipe in which representative situation where a pipe is subjected to a deficit condition according to one embodiment described herein.

FIG. 2 illustrates an example water demand allocation for an insufficient pressure condition according to one embodiment described herein.

FIG. 3 illustrates an example case where insufficient nodes are eliminated to show a shifting flow topology of a water network from full to insufficient flow regimes according to one embodiment described herein.

FIG. 4 illustrates an example process for generating a hydraulic simulation model of a water network having an insufficient flow condition according to one embodiment described herein.

FIG. 5 illustrates another example process for generating a hydraulic simulation model of a water network having insufficient and deficient flow conditions according to one embodiment described herein.

FIG. 6 illustrates an example pipe network and network details according to one embodiment described herein.

FIG. 7 illustrates an example loop network and node details according to one embodiment described herein.

FIG. 8 illustrates an example pipe network and network details according to one embodiment described herein.

FIG. 9 illustrates an example Apulian network layout according to one embodiment described herein.

FIG. 10 is an example hardware diagram of a general purpose computer according to one embodiment described herein.

### DETAILED DESCRIPTION

As discussed above, the performance and characteristics of water networks can be evaluated through simulation using computing devices. Most conventional hydraulic modeling software packages, however, are unable to model all the possible ranges of water pressure and demand in water networks. In operation, water networks can face certain problems that interrupt the operation and ability of the water networks to provide sufficient water pressure to all network elements. For example, among other problem conditions, insufficient and deficient flow conditions can occur in certain pipes and nodes.

An insufficient flow condition can occur if the total hydraulic head in one or more pipes leading to water meters or access points is zero. This condition can occur if the total hydraulic head at a water meter or access point, for example, is less than the elevation of the water meter or access point. In many conventional hydraulic modeling software packages, an insufficient flow condition might be identified as a negative value of hydraulic head or pressure at certain nodes. The concept of negative hydraulic head, however, violates basic principles of the way water flows in pipes.

A deficient flow condition can occur, for example, if the total hydraulic head in one or more pipes leading to water meters or access points is greater than zero but less than that needed to serve demand. For example, for a building of significant height (e.g., a skyscraper), a deficient flow condition might result in the occupants of lower floors having water (although at low pressure) but the occupants of higher floors having no water flow. Thus, there may be some water pressure at water meters or access points, but not enough to supply the water to all upper levels of buildings. A deficient flow condition can occur when the total hydraulic head at a node is greater than the elevation but less than the minimum total hydraulic head sufficient to supply water to all users.

Various studies have focused on the relationship between pressure and demand at deficient nodes under the assumption that flow is sufficient in the nodes and pipes. Other efforts have looked at the drawback in node demands for both insufficient and deficient nodes by balancing demand using imaginary tanks set to these nodes, without accounting for the demand reduction due to flow discontinuity in nodes and pipes.

One challenge in the field is to identify insufficient and deficient flow conditions at various nodes in water distribution networks and to expand on the ability to simulate conditions in water networks including such insufficient and deficient flow conditions. New ways to accurately identify and evaluate insufficient and deficient flow conditions in water networks is important because conventional hydraulic models are not designed to account for the circumstances that can occur for low pressure and flow conditions. In practice, insufficient pressure nodes can be identified based on meter locations which exhibit a recorded shortage in supply or using instruments such as electronic meters, pressure loggers, bulk meters, etc. These tools can be applied in some cases, but it is difficult to cover every node in water distribution networks. Additionally, it would be beneficial to identify problems without the significant costs associated with electronic meters, pressure loggers, bulk meters, etc., and before the construction of new (or the modifications of existing) water networks.

In the context outlined above, the embodiments described herein include hydraulic modeling techniques capable of evaluating the behavior of water networks under insufficient and deficient flow conditions. The embodiments can be used for the simulation and real-time monitoring of demand problems in water networks including insufficient and deficient pressure nodes.

As noted above, EPANET2 is an example hydraulic modeling package that can be used to simulate water flow and quality in pressurized water networks. EPANET2 can be programmed, at least in part, using the Global Gradient Algorithm (GGA). In the GGA, the water pipe flow equation is given by:

Hᵢ=Hⱼ+Kᵢⱼ|Qᵢⱼ|ⁿ⁻¹Qᵢⱼ, (1)

Where Hᵢ is the hydraulic head at node i, Kᵢⱼ is constant of pipe properties which is a function of pipe roughness, diameter, and length, Qᵢⱼ is flow rate in the pipe, and n is constant exponent defined based on type of formula used for evaluating the head loss. The water flow mass balance for nodes is given by:

ΣᵢQ=qᵢ, (2)

where qᵢ is the demand at node i, and Q is flow rate at connected pipes.

The flow equation shown in Equation 1 and the flow mass balance equation shown in Equation 2 can be implicitly set in global matrices and numerically solved for pipe flow in all pipes and pressure heads in all nodes. An example set of global matrices is as follows:

$$[ \begin{matrix}{A}_{11} & {A}_{12} \\ {A}_{21} & 0\end{matrix} ] [ \begin{matrix}Q \\ H\end{matrix} ] = [ \begin{matrix}{A}_{0} {H}_{0} \\ q\end{matrix} ] , \qquad ( 3 )$$

where A₁₁ is a diagonal matrix describing the energy loss in pipes and pumps, A₂₁ and A₁₂ are the incidence matrix defining the network connectivity, A₁₂ is the transpose of the matrix A₂₁, Q represents the flowrate in all pipes, H represents the total head at all nodes, q is the demand at all nodes, and A₀H₀ is the source head matrix.

As formulated in Equations (1) to (3), when running under low water pressure supply, the model yields negative values of pressure at some nodes. For example, negative pressure can occur when the hydraulic head at a node is less than the elevation at the node. For connected pipes, if an end node is calculated to have a negative pressure, flow is disrupted and water is not delivered to nodes of higher elevation.

The fundamental assumption for the pipe flow equation shown in Equation (1) is that the pressure at both ends of pipes is greater than zero. The continued application of (e.g., calculation from) results using the pipe flow equation shown in Equation (1) when negative pressure values are obtained for certain nodes, however, violates basic principles of the way water flows in pipes. At the same time, the water flow mass balance equation shown in Equation 2 is satisfied as long as water flow in connected pipes is maintained.

Some approaches have modified the original form of Equation (3) in order to simulate disrupted pipes when subject to routine maintenance, for example. This method eliminates the flow equation from the relevant matrices. However, the elimination method applies only for the disconnected pipes and is not intended to cover all pipes connected to deficient nodes. Other approaches have attempted to simulate pressure deficiencies by using EPANET2 tools, such as using check and flow control valves to eliminate the flow equation for certain pipes. However, when a deficit condition occurs at a deficit node in a water network, all pipes connected to the deficit node are in a no flow condition. Thus, the flow equation does not apply to them. In addition, the pressure at such deficit nodes needs to be set to an elevation level of “zero pressure,” and there is no demand supply at these nodes.

Water access points (e.g., indoor faucets, shower taps, etc.) connected to water pipes can be affected by the amount of water pressure at various nodes in a water network, potentially leading to a deficient flow condition). One example of the relationship between node demand and node pressure is shown in Equation (4), although other relationships between node demand and pressure have been studied. The relationship between node demand and node pressure can be provided as:

$${q}_{i}^{avl} \{ \begin{matrix}{q}_{i} & full flow & if {H}_{i} \geq {H}_{i}^{min} \\ {( \frac{{H}_{i} - {H}_{min}}{{H}^{d} - {H}_{min}} )}^{1 / 2} & partial flow & if {H}_{min} < {H}_{i} < {H}^{d} \\ 0 & no flow & if {H}_{i} \leq {H}_{min}\end{matrix} , \qquad ( 4 ) .$$

where Hₘᵢₙ is the minimum head pressure, and H^{d} represents a desirable head for all network outlets at the node i.

Hydraulic models have also been used to simulate the relationship between demand and hydraulic head at nodes in a water network. One such model is referred to as the Head Driven Algorithm (HDA). The HDA is derived from the GGA, but also the demand on nodes is adjusted to be compatible with pressure at the nodes (e.g., as in Equation (4)). Then, the demands on nodes are included in the mass balance of flow for each of the nodes. In the HDA, it is also assumed that a pressure deficiency from demand flow in nodes causes insufficient pressure in the network. In the HDA, the flow equation is used in all pipes in the network and it is not affected by insufficient flow in the pipes. As a result, for HDA, it can always be assumed that flow exists along all pipes. It is also expected that there are no empty pipes or air entering the pipes under low supply conditions. These assumptions or expectations, again, violate certain basic principles of the way water flows in pipes.

An important factor in the industry of water utilities is the variation in customer water consumption and the identification of the amount of water that should be delivered to the water network. For a new area, engineering personnel can rely on design tables to estimate water demand based on the area plan. For network expansion and for an existing network, the water demand may be estimated based on an existing billing system and available information of existing and future expansion areas. Finally, for operational purposes, water demand can be estimated directly from existing billing meters, which can be helpful to determine the proper amount of water flow and pressure that should be supplied to the network.

In general, there are three methods where water demand can be estimated at nodes. The three methods include area-based, point-based, and uniform methods. With these methods, water demand is estimated from the population, the area, and/or local meters. In all three methods, it is assumed that demand at side nodes is distributed uniformly along the half distant of the connected pipes. In addition, the three methods assume the water network works under normal conditions. When water is not sufficiently flowing in the pipes, there is an unbalanced distribution in collecting water consumption information from local meters. The unbalanced distribution can result from the fact that demand is collected in a disproportionate manner from saturated nodes, while at the same time water meters at deficit nodes are unable to collect relevant data on the actual demand at those deficit nodes.

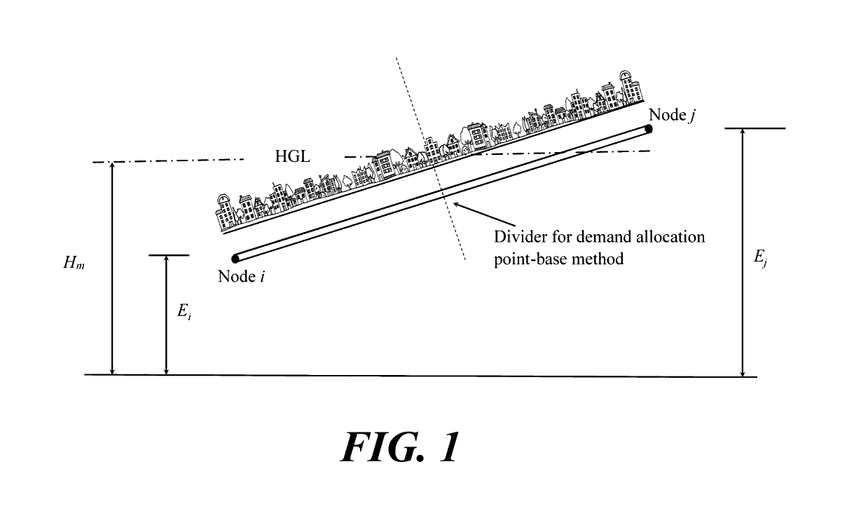

FIG. 1 shows a representative situation where a pipe is subjected to a deficit condition. As shown in FIG. 1, Node “i” is operating at a flow condition and Node “j” is operating under a deficit condition. In this case, Node “i” may collect more or less water than the actual amount calculated using standard and demand allocation methods. That is because the sufficient flow outlets along the pipe line will accumulate at Node “i” and Node “j” has no account for demand. Assuming a linear relationship between the heads of Node “i” (i.e., Hᵢ) and Node “j” (i.e., Hⱼ), the linear relationship can be solved based on the elevations of the nodes (i.e., Eᵢ and Eⱼ) and the head of the water in which the water flow can reach Hₘ and be estimated as follows:

$${H}_{m} = {H}_{i} - \frac{( {H}_{i} - {H}_{j} ) ( {H}_{i} - {E}_{i} )}{( {H}_{i} - {H}_{j} + {E}_{j} - {E}_{i} )} , where {H}_{i} > {E}_{i} and {H}_{j} < {E}_{j} , \qquad ( 5 ) .$$

where Hₘ is the minimum head, Hᵢ is the hydraulic head at node i, Hⱼ is the hydraulic head at node j, Eᵢ is elevation of the node i, and Eᵢ elevation of the node j.

Assuming a linear relationship between the demands at Node “i” and the deficit Node “j”, the change in demand (i.e., Δqᵢⱼ) at Node “i”, which is in connection with deficit node Node “j”, will be:

$$\begin{matrix}Δ {q}_{ij} = {q}_{i} \frac{{l}_{ij}}{{\sum }_{{n}_{{c}_{i}}} {l}_{ik}} \frac{( 2 {H}_{m} - {E}_{i} - {E}_{j} )}{( {E}_{j} - {E}_{i} )} , where {H}_{i} > {H}_{min} and {E}_{i} < {H}_{m} < ( {E}_{i} + {E}_{j} ) / 2 \\ and & ( 6 a ) \\ Δ {q}_{ij} = {q}_{j} \frac{{l}_{ij}}{{\sum }_{{n}_{{c}_{j}}} {l}_{jk}} \frac{( 2 {H}_{m} - {E}_{i} - {E}_{j} )}{( {E}_{j} - {E}_{i} )} , where {H}_{i} > {H}_{min} and ( {E}_{i} + {E}_{j} ) / 2 < {H}_{m} < {E}_{j} , & ( 6 b )\end{matrix}$$

where the qᵢ and qⱼ are the demands calculated from the demand allocation method based on flow conditions.

The change in demand from Equation (6a) is expected to be a negative value and Equation (6b) is expected to be a positive value. The available demand at Node “i” (e.g., qᵢ^{avl}) which is connected to the deficit node, will be:

$${q}_{i}^{avl} = {q}_{i} + {Σ}_{{n}_{{c}_{i}}} {Δq}_{ij} . \qquad ( 7 )$$

The summation term in Equation (7) depends on the number of deficit pipes connected to the Node “i”. It is important to mention here that Equation (7) is written for a looped network in which the demand on the Node “i” may have different sources under normal conditions.

Experiments have been conducted to evaluate different methods used for hydraulic head demand relationships. Under at least some conditions, the experiments have concluded that the format demonstrated in Equation (4) can be a better fit as compared to other methods. Combining Equations (4), (6), and (7), the available demand at a node can be defined as follows:

$${q}_{i}^{aval} \{ \begin{matrix}{q}_{i} & flow in node and & {H}_{m} > {E}_{j} and \\ & connected pipes & {H}_{i} > {H}^{d} \\ {{q}_{i} ( \frac{{H}_{i} - {H}_{min}}{{H}^{d} - {H}_{min}} )}^{1 / 2} & partial flow in node , & {H}_{m} > {E}_{j} and \\ & still flow in pipes & {H}_{min} < {H}_{i} < {H}^{d} \\ {( \frac{{H}_{i} - {H}_{min}}{{H}^{d} - {H}_{min}} )}^{1 / 2} ( {q}_{i} + {\sum }_{{n}_{{c}_{i}}} Δ {q}_{ij} ) & partial flow in node & {E}_{i} < {H}_{m} < {E}_{j} and \\ & i and no flow & {H}_{min} < {H}_{i} < {H}^{d} \\ & in j pipes & \\ {q}_{i} + {\sum }_{{n}_{{c}_{i}}} Δ {q}_{ij} & flow in node i and & {E}_{i} < {H}_{m} < {E}_{j} and \\ & no flow in j pipes & {H}_{i} > {H}^{d} \\ 0 & no flow in node and & {E}_{i} < {H}_{m} < {E}_{j} and \\ & flow in pipes & {H}_{i} < {H}_{min} \\ 0 & no flow in node and & {H}_{i} < {E}_{i} \\ & pipes “ insuficient ” & \end{matrix} . \qquad ( 8 )$$

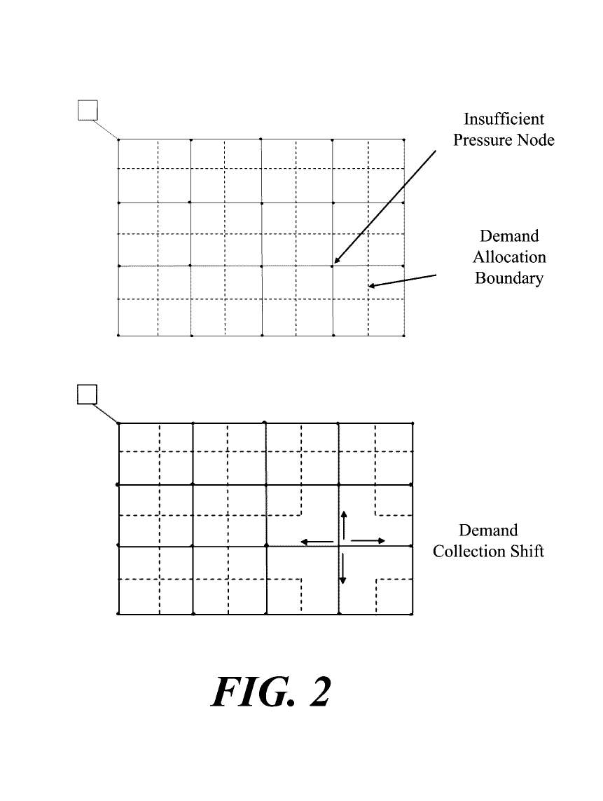

For monitoring using sensors in electronic meters, for example, water demand can be determined directly from meters by knowing the coordinates of the meters. In that case, demand can be estimated based on the actual use of water meters, and it may not be necessary to estimate deficient and insufficient pressure calculations to evaluate demand at the nodes. However, for insufficient pressure nodes, the boundary of the demand distribution at insufficient pressure nodes may need to be shifted to the next adjacent nodes. FIG. 2 illustrates an example water demand allocation for an insufficient pressure condition. In this condition, the meters are shifted to the nearest allocated nodes for demand node collection.

EPANET2 includes a number of tools, and each tool has simulation boundary conditions for specifying the different elements that can be found on a wide range of water networks. These tools assume that the network operates with sufficient pressure and satisfies the demand at all the nodes. In order to simulate hydraulic models under low pressure conditions, however, at least two types of boundary conditions should be defined. First, no or insufficient pipe flow conditions should be defined. Second, variable demand at junctions or deficit demand should be defined. As described above, a number of different relationship formulas can be used to evaluate demand when the hydraulic head at one or more nodes is greater than the minimum hydraulic head but less than the desired or necessary hydraulic head for service to all users. When the nodes are subjected to insufficient flow, simulated boundary conditions can be defined for insufficient nodes and their connected pipes.

For an insufficient condition, the demand at the node will drop to zero, and there is no flow at the connected pipes. For this purpose, Equation (9) and Equation (10), provided below, can be used to simulate these conditions. In one case, Equation (9) can be applied for all pipes that are connected to insufficient nodes, and Equation (10) can be applied for all insufficient nodes. A couple system of Equations (9) and (10) is used simultaneously to satisfy boundary conditions. Solving the combination of Equations (9) and (10) can reach only the trivial solution at the insufficient condition. An insufficient condition here means no flow in connected pipe(s) and, for the regular system of Equation (1), the flow equation is satisfied despite if negative pressure occurs in at least one of the adjacent nodes. On the other hand, the only condition at which the summation of the pipe flow Equation (10) at an insufficient node will reach zero is when the head at the deficit node (Hⱼ) reaches the elevation value (Eⱼ). In this context, zero pressure can occur when the head at the node (Hᵢ) is equal to (or greater than) the node elevation (Eᵢ). In addition, the mass balance of the demand flow at the insufficient pressure flow must be zero (i.e., qᵢ=0).

Eⱼ=Hⱼ+Kᵢⱼ|Qᵢⱼ|ⁿ⁻¹Qᵢⱼ (9), and

ΣⱼQ=qⱼ^{avl}0 (10).

Applying Equations (9) and (10) in combination for the insufficient condition will not change the form of the system of global matrices when GGA is applied. In GGA, the heads in the nodes and flow in pipes are numerically solved for a known network characterization, except for the elevation of the nodes (e.g., as in Equation (3)). The elevation of a node is considered in the analysis when calculating the node pressure after the numerical simulation. In various embodiments, the elevation of a node is introduced in the simulation in order to compensate for the pressure on the nodes under a deficient condition. According to Equation (9), when the flow in the connected pipes diminishes due to insufficient pressure, the head at the deficit nodes will be equal to the value of the nodes elevation rather than a negative value.

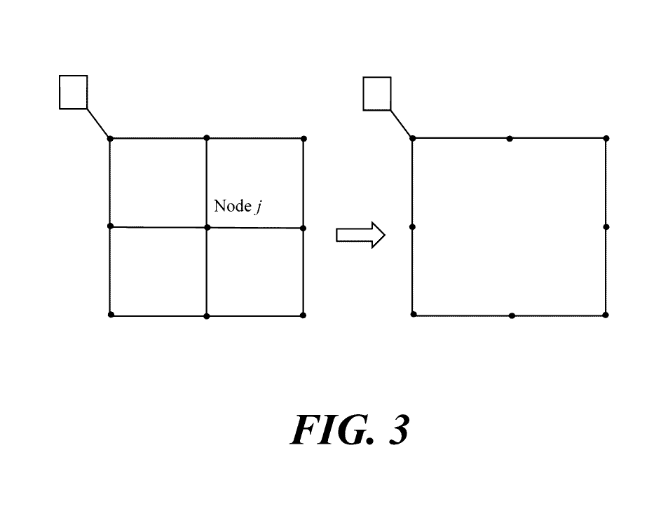

Another way to solve the problem of nodes affected by negative pressure values is to eliminate the insufficient nodes and pipes connected to the insufficient nodes. In that context, FIG. 3 illustrates an example case where insufficient nodes are eliminated to show a shifting flow topology of a water network from full to insufficient flow regimes. In FIG. 3, the number of elements is reduced from 13 to 9 pipes, and the number of nodes is reduced from 9 to 8. To avoid the singularity in the numerical simulation, the size of the matrices can be changed. The change in matrices can make the solution process more difficult to apply, especially if the insufficient nodes are not recognized in a first run.

In some cases, the combination of Equations (9) and (10) can be used for setting boundary condition settings for deficit nodes in simulations. The boundary condition settings established using the combination of Equations (9) and (10) can give the same (or nearly the same) results as when insufficient nodes are eliminated. For both cases, the change in demand due to any imbalanced distribution can be considered. As described in further detail below, when using a combination of Equations (9) and (10), there is no need to change the sizes of the matrices, even when a simulation exposes negative pressure nodes over a number of iterations. All these simulations can be applied once the deficit nodes are identified in the network.

When flow in some part of a water network is interrupted, identifying the deficit zone can be a relatively difficult task. When hydraulic head at a node is less than the minimum total hydraulic head needed to supply water to all users, a number of results can occur. First, the demand can serve in partial flow, called pressure deficiency or deficient flow at the node. If the hydraulic head at the node lies below the elevation of the node, the node will be subjected to insufficient pressure or insufficient flow condition. As discussed earlier, for insufficient pressure supply, no flow will occur in either the node or pipes connected to the node. These insufficient pressure nodes and pipes do not act as part of the network, which is not the case for node deficiency or deficient flow at a node. For insufficient pressure nodes, the adjacent insufficient nodes and their connected pipes can be considered deficit zone (DZ).

To avoid encountering DZs during simulations, one work-around has been to use an additional set of imaginary tanks at deficient and/or insufficient pressure nodes. However, this process can require several that are difficult to apply, especially for large networks. Further, accounting for the imbalanced demand from the insufficient pressure nodes may be difficult to compensate for. For this reason, it would be helpful to identify DZs while insufficient pressure nodes and connected pipes are maintained in water networks for simulations.

Applying GGA, the flow and conservation equations can be progressively applied even when pressure at certain nodes and connected pipes are simulated to have negative values. This means that, in using GGA method, the flow equation is still being used even when water flow is disconnected in deficit pipe. At least, the node simulated to have the largest negative value of hydraulic pressure is an insufficient pressure node. The other negative pressure nodes, if any exist, are not necessarily insufficient in pressure since the flow equation is not subjected to all pipes. The flow could move in a different path to avoid those other insufficient pressure nodes. Thus, iterative steps can be applied to progressively identify any deficit zone in a water network, and demand at the nodes in the deficit zone can be adjusted over a number of iterative steps. Similar procedures can be applied when the pressure at certain nodes is subjected to a pressure deficiency. For pressure deficiency, however, it is not necessary to change the topology of the water network. Instead, only the demand flow at certain nodes needs to be adjusted as shown in Equation (4) and Equation (8).

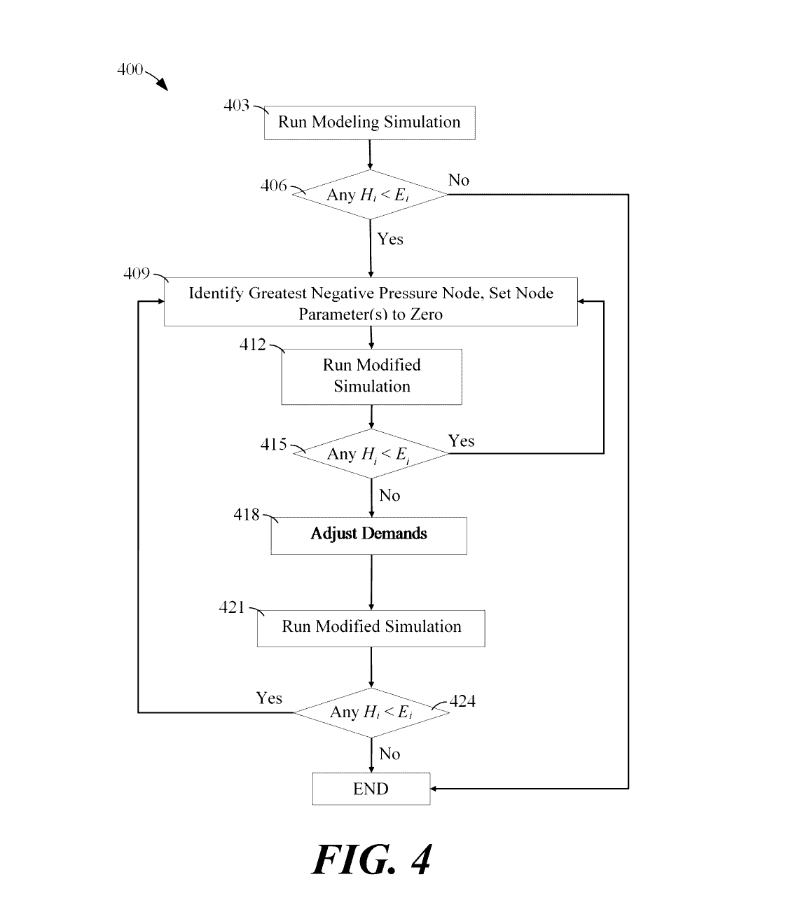

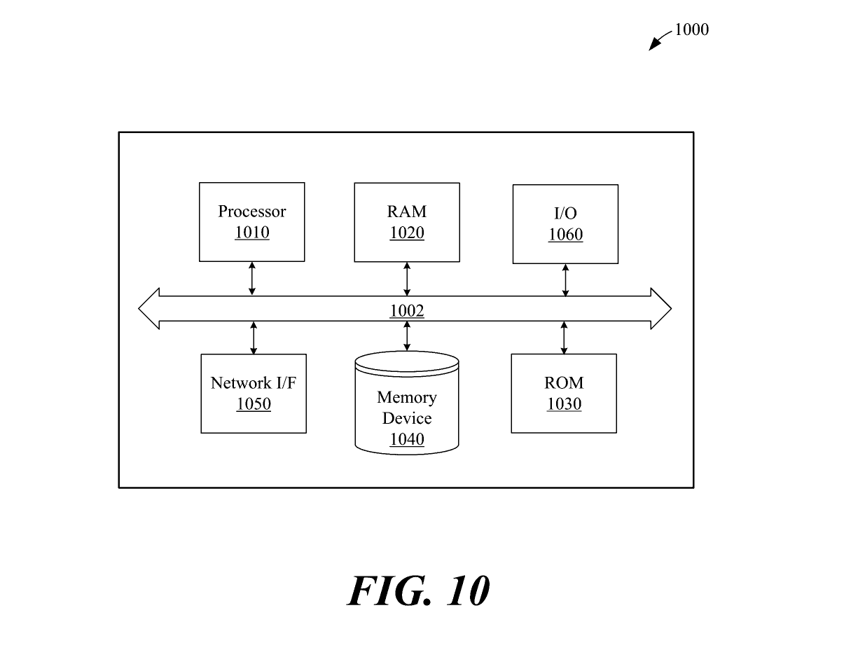

FIG. 4 is a flow chart illustrating an example process 400 for generating a hydraulic simulation model of a water network having an insufficient flow condition according to one embodiment described herein. The process 400 can be executed using one or more computing devices, such as the example computing device described below with reference to FIG. 10, or others known in the field. Thus, the process 400 is not limited to execution or performance on any particular type of device(s).

The process 400 identifies a deficit zone and calculates a solution for demand associated based on the adjustment of deficit nodes. Then, the process 400 checks if the adjusted demand affects the other nodes not in a deficit state. The various embodiments of the present disclosure can also compensate for unbalanced demand due to changes in the network topology. In addition, the embodiments can use the GGA method, which can run in a more stable fashion than the HDA method in certain cases. As such, use of the GGA is extended according to the process 400 to overcome the occurrence of negative pressure in various solutions.

Beginning at reference numeral 403, a computing device is configured to run, execute, or evaluate a water distribution modeling application or model to generate a number of hydraulic pressure head measurements associated with respective nodes in a water distribution network. The modeling application can be the EPANET, EPANET2, or similar hydraulic modeling package, and the water distribution network can be any network (e.g., a network of any size and/or shape) defined in the hydraulic modeling package. In some cases, the pressure head measurements can be determined based in part on measurement data captured using sensors at nodes in the water distribution network, as that data can be collected through a supervisory control and data acquisition (SCADA) control system, for example.

At reference numeral 406, the computing device is configured to identify any nodes calculated to have a hydraulic pressure head measurement less than a corresponding elevation value for the node. In that context, a node having a pressure head measurement less than its corresponding elevation value is subject to an insufficient (i.e., negative value) pressure condition. The computing device can thus identify a subset of the nodes in the water distribution network that are subject to an insufficient pressure condition.

At reference numeral 409, the computing device is configured to identify a most (e.g., greatest absolute value) negative pressure node from the subset identified at reference numeral 406. The computing device is also configured to adjust certain parameters associated with the greatest negative pressure node. For example, the computing device can set the parameters for the greatest negative pressure node to zero pressure and zero demand. The computing device can also set the water flow to all pipes connected to the greatest negative pressure node to zero. In one example case, the computing device can set the water flow to zero in all connected pipes in the relative matrices by simulating that condition a combination of one or both of Equations (9) and (10), as described above.

In some cases, the parameters of more than one negative pressure node can be adjusted at reference numeral 409. For example, the computing device can identify a certain number of greatest negative pressure nodes from the subset identified at reference numeral 406. In that case, the computing device can adjust the parameters associated with all the identified nodes.

At reference numeral 412, the computing device is configured to run or execute the water distribution modeling application again, based on the node parameters and/or pipe parameters set at reference numeral 409. The execution of the modeling application at reference numeral 412 is similar to that performed at reference numeral 403, except for the changes in parameters set at reference numeral 409.

Next, at reference numeral 415, the computing device is configured to identify any nodes calculated to have a hydraulic pressure head measurement less than a corresponding elevation value for the node. Again, a node having a pressure head measurement less than its corresponding elevation value is subject to an insufficient (i.e., negative value) pressure condition. The computing device can thus identify a second subset of the nodes in the water distribution network that are subject to an insufficient pressure condition. In some cases, the nodes identified as being subject to an insufficient pressure condition at reference numeral 415 can be different than those identified at reference numeral 406. This can be due, in part, to the change in performance of the water distribution simulation after the zero flow, the zero pressure, and the zero demand parameters were set at reference numeral 409.

If at least one node having a hydraulic pressure head measurement less than the corresponding elevation value is identified at reference numeral 415, the process proceeds back to reference numeral 409 for another iteration. In that case, the computing device can again identify one or more greatest negative pressure nodes among those identified at reference numeral 415. The computing device can also adjust certain parameters associated with those greatest negative pressure nodes. For example, the computing device can set the parameters for the greatest negative pressure nodes to zero pressure and zero demand. The computing device can also set the water flow to all pipes connected to the greatest negative pressure nodes to zero. For example, the computing device can set the water flow to zero in all connected pipes in the relative matrices by simulating that condition a combination of one or both of Equations (9) and (10), as described above.

On the other hand, if no nodes having a hydraulic pressure head measurement less than the corresponding elevation value are identified at reference numeral 415, the process proceeds to reference numeral 418. At reference numeral 418, the computing device is configured to adjust the demand associated with one or more nodes based on the hydraulic pressure head measurements calculated at reference numeral 412. For example, adjustments can be made according to the available hydraulic pressure head and node elevation according to Equations (6), (7), and (8). Based on the available hydraulic pressure as compared with the node elevation at the end part of the pipe, the demand can be adjusted for compensating the unbalance distribution due to pipe deficiency.

At reference numeral 421, the computing device is configured to run or execute the water distribution modeling application again, based on the adjustment of the node demand performed at reference numeral 418. The execution of the modeling application at reference numeral 421 is similar to that performed at reference numerals 403 and 412, except for the changes and adjustments made at other steps in the process 400.

At reference numeral 424, the computing device is again configured to identify any nodes calculated to have a hydraulic pressure head measurement less than a corresponding elevation value for the node. Again, a node having a pressure head measurement less than its corresponding elevation value is subject to an insufficient (i.e., negative value) pressure condition. The computing device can thus identify a third subset of the nodes (if any) in the water distribution network that are subject to an insufficient pressure condition. In some cases, the nodes identified as being subject to an insufficient pressure condition at reference numeral 424 can be different than those identified at reference numerals 406 and/or 415. This can be due, in part, to the changes and adjustments made at other steps in the process 400.

If at least one node having a hydraulic pressure head measurement less than the corresponding elevation value is identified at reference numeral 424, the process proceeds back to reference numeral 409 for another iteration. On the other hand, if no nodes having a hydraulic pressure head measurement less than the corresponding elevation value are identified, the process can end.

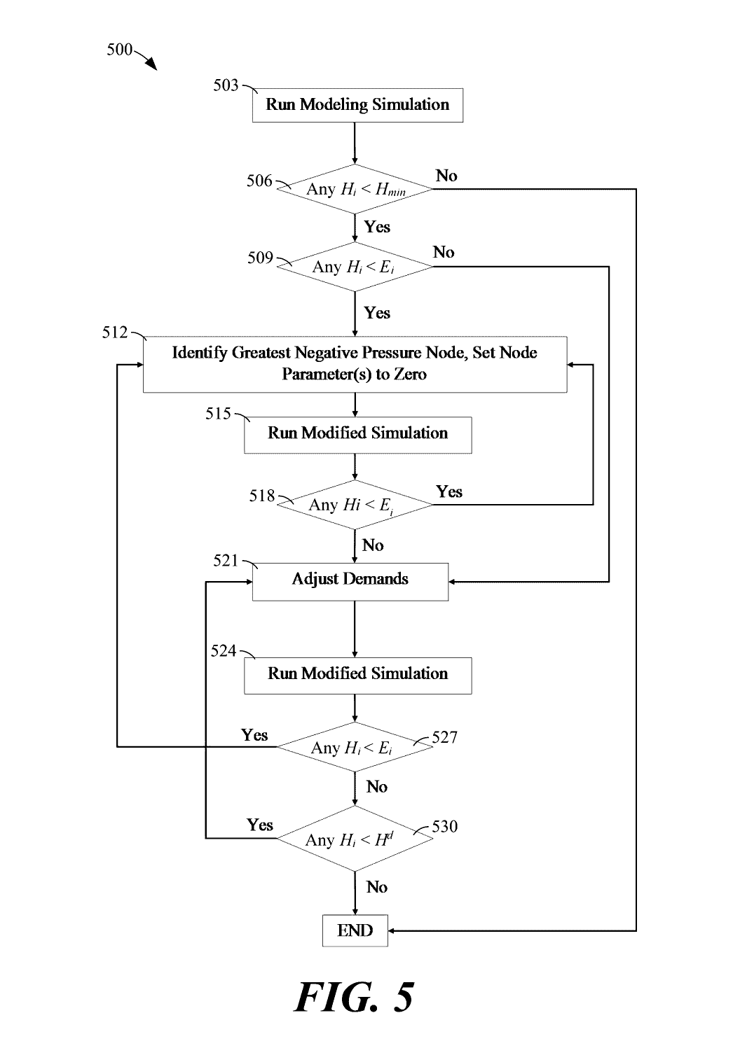

Turning now to FIG. 5, shown is one example of a process 500 for a procedure when the minimum head plays a relatively significant role on decreasing the demand values. The application can be executed as an iterative procedure that includes in a first iteration identifying a deficit zone as described before. The second iteration can evaluate the demand at the deficit nodes until pressure heads stabilize. By this analysis and in comparison with HDA, no flow will occur at the pipes that are connected to the insufficient nodes. This shows the capability of the embodiments of the present disclosure for solving both insufficient and deficit flow conditions. In addition, various embodiments of the present disclosure use the GGA in which there is no need to estimate the initial heads when using the Newton Raphson method for solving the nonlinear equation system. However, it may require more than one run, but it will numerically stabilize in the conversion process.

FIG. 5 illustrates another example process 500 for generating a hydraulic simulation model of a water network having insufficient and deficient flow conditions according to one embodiment described herein. The process 500 can be executed using one or more computing devices, such as the example computing device described below with reference to FIG. 10, or others known in the field. Thus, the process 500 is not limited to execution or performance on any particular type of device(s).

Beginning at reference numeral 503, a computing device is configured to run or execute a water distribution modeling application to generate a number of hydraulic pressure head measurements associated with respective nodes in a water distribution network. The modeling application can be the EPANET, EPANET2, or similar hydraulic modeling package, and the water distribution network can be any network (e.g., a network of any size and/or shape) defined in the hydraulic modeling package. In some cases, the pressure head measurements can be determined based in part on measurement data captured using sensors at nodes in the water distribution network, as that data can be collected through a supervisory control and data acquisition (SCADA) control system, for example.

At reference numeral 506, the computing device is configured to identify any nodes calculated to have a hydraulic pressure head measurement greater than the corresponding elevation of the node but less than a minimum total hydraulic head needed to supply water to all users of the node. In that context, a node having a pressure head measurement greater than its corresponding elevation value is not subject to an insufficient pressure condition, but could still be subject to a deficient flow condition. If no nodes are identified at reference numeral 506, the process ends as shown in FIG. 5. On the other hand, if at least one node is identified at reference numeral 406, the process proceeds to reference numeral 509.

At reference numeral 509, the computing device is configured to identify any nodes calculated to have a hydraulic pressure head measurement less than a corresponding elevation value for the node. In that context, a node having a pressure head measurement less than its corresponding elevation value is subject to an insufficient (i.e., negative value) pressure condition. The computing device can thus identify a subset of the nodes in the water distribution network that are subject to an insufficient pressure condition. If no nodes are identified at reference numeral 509, the process ends as shown in FIG. 5. On the other hand, if at least one node is identified at reference numeral 509, the process proceeds to reference numeral 512.

At reference numeral 512, the computing device is configured to identify a most (e.g., greatest absolute value) negative pressure node from the subset identified at reference numeral 406. The computing device is also configured to adjust certain parameters associated with the greatest negative pressure node. For example, the computing device can set the parameters for the greatest negative pressure node to zero pressure and zero demand. The computing device can also set the water flow to all pipes connected to the greatest negative pressure node to zero. In one example case, the computing device can set the water flow to zero in all connected pipes in the relative matrices by simulating that condition a combination of one or both of Equations (9) and (10), as described above.

In some cases, the parameters of more than one negative pressure node can be adjusted at reference numeral 512. For example, the computing device can identify a certain number of greatest negative pressure nodes from the subset identified at reference numeral 406. In that case, the computing device can adjust the parameters associated with all the identified nodes.

At reference numeral 515, the computing device is configured to run or execute the water distribution modeling application again, based on the node parameters and/or pipe parameters set at reference numeral 512. The execution of the modeling application at reference numeral 515 is similar to that performed at reference numeral 503, except for the changes in parameters set at reference numeral 512.

Next, at reference numeral 518, the computing device is configured to identify any nodes calculated to have a hydraulic pressure head measurement less than a corresponding elevation value for the node. Again, a node having a pressure head measurement less than its corresponding elevation value is subject to an insufficient (i.e., negative value) pressure condition. The computing device can thus identify a second subset of the nodes in the water distribution network that are subject to an insufficient pressure condition. In some cases, the nodes identified as being subject to an insufficient pressure condition at reference numeral 518 can be different than those identified at reference numeral 509. This can be due, in part, to the change in performance of the water distribution simulation after the zero flow, the zero pressure, and the zero demand parameters were set at reference numeral 512.

If at least one node having a hydraulic pressure head measurement less than the corresponding elevation value is identified at reference numeral 518, the process proceeds back to reference numeral 512 for another iteration. In that case, the computing device can again identify one or more greatest negative pressure nodes among those identified at reference numeral 415. The computing device can also adjust certain parameters associated with those greatest negative pressure nodes. For example, the computing device can set the parameters for the greatest negative pressure nodes to zero pressure and zero demand. The computing device can also set the water flow to all pipes connected to the greatest negative pressure nodes to zero. For example, the computing device can set the water flow to zero in all connected pipes in the relative matrices by simulating that condition a combination of one or both of Equations (9) and (10), as described above.

On the other hand, if no nodes having a hydraulic pressure head measurement less than the corresponding elevation value are identified at reference numeral 518, the process proceeds to reference numeral 521. At reference numeral 521, the computing device is configured to adjust the demand associated with one or more nodes based on the hydraulic pressure head measurements calculated at reference numeral 515. For example, adjustments can be made according to the available hydraulic pressure head according to Equation (8).

At reference numeral 524, the computing device is configured to run or execute the water distribution modeling application again, based on the adjustment of the node demand performed at reference numeral 521. The execution of the modeling application at reference numeral 524 is similar to that performed at reference numerals 503 and 515, except for the changes and adjustments made at other steps in the process 500.

At reference numeral 527, the computing device is again configured to identify any nodes calculated to have a hydraulic pressure head measurement less than a corresponding elevation value for the node. Again, a node having a pressure head measurement less than its corresponding elevation value is subject to an insufficient (i.e., negative value) pressure condition. The computing device can thus identify a third subset of the nodes (if any) in the water distribution network that are subject to an insufficient pressure condition. In some cases, the nodes identified as being subject to an insufficient pressure condition at reference numeral 527 can be different than those identified at reference numerals 509 and/or 518. This can be due, in part, to the changes and adjustments made at other steps in the process 500.

If at least one node having a hydraulic pressure head measurement less than the corresponding elevation value is identified at reference numeral 527, the process proceeds back to reference numeral 512 for another iteration. On the other hand, if no nodes having a hydraulic pressure head measurement less than the corresponding elevation value are identified, the process can proceed to reference numeral 530.

At reference numeral 530, the computing device is configured to identify any nodes calculated to have a hydraulic pressure head measurement less than a corresponding desirable head pressure for the node. If at least one node having a hydraulic pressure head measurement less than the corresponding desirable head pressure is identified at reference numeral 530, the process proceeds back to reference numeral 521 for another iteration. On the other hand, if no nodes having a hydraulic pressure head measurement less than the corresponding desirable head pressure are identified, the process can end as shown in FIG. 5.

Empirical simulations using the processes illustrated in FIGS. 4 and 5 have been performed. Various water networks were used to illustrate and test the embodiments. One advantage of the embodiments is the ability to use the GGA, as used in the current version of the EPANET2. This may increase the number of runs, but it is still more stable and follows the same mathematical approach of GGA. In addition, no pressure derivatives have been used, which can cause poor convergence of the solver. It has been shown that the disadvantage of the GGA method is that high negative pressure may cause instability in the precision of the program. The various embodiments of the present disclosure can overcome this concern and provide smoother convergence.

Finally, for the use of online runs, the demand at the nodes may not be adjusted for any formula currently available for the pressure deficiency condition. This is case because the pressure deficiency is calculated directly from the automated meter system over a short time period. However, the demand may need to be adjusted for insufficient pressure node, as discussed above (e.g., as in FIGS. 2 and 3). In such cases, the same steps can be followed as discussed above with refernce to FIG. 4, but the adjusted demand can be estimated using a program for the demand allocation based on using the coordinates of the electronic meters. In some embodiments, this may be a simpler approach since the demand allocation program can carry out the adjustment of the demand directly from the local meters. The demand allocation of such cases may use Geographic Information System (GIS) software, for example. This method is good for demand allocation of short time period calculations for avoiding the pressure deficient demand estimation, but should also be adjusted for the estimation of insufficient pressure demand.

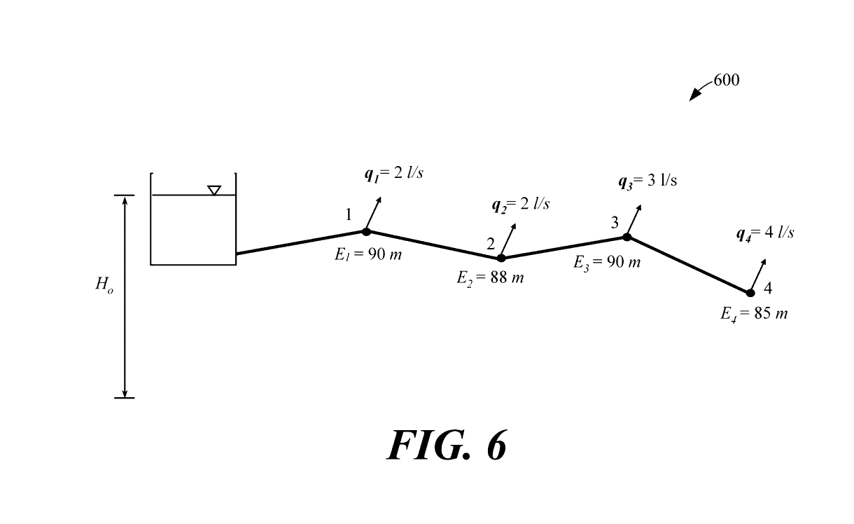

In one empirical example, the focus of benchmarking is on insufficient pressure conditions. FIG. 6 illustrates an example pipe network 600 and network details according to one embodiment described herein. According to the network 600, a source tank delivers water flow to four pipes which are connected in a series arrangement. The Hazen-Williams coefficients used for all pipes is 130 and the length of all pipes is 500 m. The fire flow at node 4 is set to a constant flow rate of 4 liters per second. To demonstrate an insufficient pressure condition, the minimum head is assumed to be zero and there is no limit for the desired head. However, this is the typical case where the demand point is directly connected to an underground tank, as is done in many countries. In this case, the head flow relationships are not considered. The only factors that may be considered are insufficient and fire flow.

In water supply systems, there are two types of systems where the water moves in the water networks. The pipes in a water network can be structured in either a looped network or a series network arrangement. When a looped water network operates under insufficient pressure, water can find alternative ways of bypassing certain nodes or zones. In contrast, in a series water network, the water flow in pipes is restricted by the source tank. As a result, different algorithms can be used for looped and series networks under insufficient flow conditions. In the network 600, a series water network is used to demonstrate a simulation different than that for a looped water network.

For the system to be able to deliver water flow to the network 600, the head at the source tank has to be greater than the elevation of the first pipe. Otherwise, no water will be able to be delivered to the system, even if the head at the source is greater than some of elevations of the later nodes. The process applies Equations (1) and (2) at each pipe and node. In the beginning, the demands at all nodes are assumed to be the design values. From the mass balance of the whole pipe system, the flow delivered from the source tank is the total amount of the demand of all nodes. Knowing this fact and by applying Equation (1), the hydraulic head at the first node can be estimated. In sequence, Equation (2) can be applied at the first node to estimate the flow in the second pipe and, sequentially, the flow and head can be estimated for later pipes and nodes. If a negative pressure is calculated for a node, the process stops and the flow cannot be delivered to the later (i.e., further-away) pipes and nodes. Different runs for different head elevations of the source tank have been executed and values are presented in Table 1 and Table 2 below. When sufficient pressure is presented, the fire flow at node 4 can match the full value and can affect the demand at the other nodes (Table 1 at tank head is greater than 96.13 m).

Referring to Table 2, when insufficient pressure is controlling water flow in the network, the total head at all of the pipes is equal to the amount of the head at the tank that rises above the first elevation node. This shows that the total head lost at the pipes is the controlling factor in insufficient flow situations. It can be seen that node 3 is the critical point in the network since it recorded the lowest value in the pressure head. For the fire flow, node 1 has recorded the highest values in pressure values, which is considered a critical point for high pressure. The high pressure can cause pipes to burst when the height of the tank is an insignificant amount. In addition, node 3 is the most affected node from the increase in the demand at node 4 due to the fire flow condition.

TABLE 1
Results of Head and Demand Benchmark Example

| | Nodes | | | | | | |
|---|---|---|---|---|---|---|---|
| | Node | | | | | | |
| | 0 | 1 | 2 | 3 | 4 | | |
| | E | | | | | Total | |
| | 90 | 90 | 88 | 90 | 85 | Supply | |
| H | 90 | 90 | 88 | 90 | 85 | 0 | Insufficient |
| Demand | | 0 | 0 | 0 | 0 | | pressure |
| P/g | 0 | 0 | 0 | 0 | 0 | | control |
| H | 91.00 | 90.32 | 90 | 90 | 85 | 3.77 | |
| Demand | | 2.00 | 1.77 | 0 | 0 | | |
| P/g | 1.00 | 0.32 | 2.00 | 0 | 0 | | |
| H | 92.00 | 90.93 | 90.17 | 90.00 | 85.00 | 4.82 | |
| Q | | 2.00 | 2.00 | 0.82 | 0 | | |
| P/g | 2.00 | 0.93 | 2.17 | 0.00 | 0 | | |
| H | 94.00 | 92.37 | 90.89 | 90.00 | 85.00 | 6.05 | |
| Demand | | 2.00 | 2.00 | 2.05 | 0 | | |
| P/g | 4.00 | 2.37 | 2.89 | 0.00 | 0 | | |
| H | 96.13 | 94.00 | 91.81 | 90.00 | 85.00 | 7.00 | Critical |
| Demand | | 2.00 | 2.00 | 3.00 | 0 | | point |
| P/g | 6.13 | 4.00 | 3.81 | 0.00 | 0 | | |
| H | 98.88 | 96.15 | 93.08 | 90.00 | 86.92 | 8.00 | Fire |
| Demand | | 2 | 2 | 0 | 4 | | flow |
| P/g | 8.88 | 6.15 | 5.08 | 0.00 | 1.92 | | control |
| H | 100 | 97.04 | 93.61 | 90.00 | 86.92 | 8.36 | |
| Demand | | 2 | 2 | 0.36 | 4 | | |
| P/g | 10 | 7.04 | 5.61 | 0.00 | 1.92 | | |
| H | 110.10 | 105.17 | 98.66 | 90.00 | 86.92 | 11.00 | |
| Demand | | 2.00 | 2.00 | 3.00 | 4.00 | | |
| P/g | 20.10 | 15.17 | 10.66 | 0.00 | 1.92 | | |

TABLE 2
Flow Rate Result in Benchmark Example

| | Pipe flow(l/s)/Head loss (m) | | | | Total |
|---|---|---|---|---|---|
| Ho | 1 | 2 | 3 | 4 | Head loss |
| 90 | 0 | 0 | 0 | 0 | 0.00 |
| | 0 | 0 | 0 | 0 | |
| 91 | 3.77 | 1.77 | 0 | 0 | 1.00 |
| | 0.68 | 0.32 | 0 | 0 | |
| 92 | 4.82 | 2.82 | 0.82 | 0 | 2.00 |
| | 1.07 | 0.76 | 0.17 | 0 | |
| 94 | 6.05 | 4.05 | 2.05 | 0 | 4.00 |
| | 1.63 | 1.48 | 0.89 | 0 | |
| 96.13 | 7.00 | 5.00 | 3.00 | 0 | 6.13 |
| | 2.13 | 2.19 | 1.81 | 0 | |
| 98.88 | 8 | 6 | 4 | 4 | 11.96 |
| | 2.73 | 3.07 | 3.08 | 3.08 | |
| 100 | 8.36 | 6.36 | 4.36 | 4 | 13.08 |
| | 2.96 | 3.43 | 3.61 | 3.08 | |
| 110.09 | 11.00 | 9.00 | 7.00 | 4 | 23.17 |
| | 4.92 | 6.51 | 8.66 | 3.08 | |

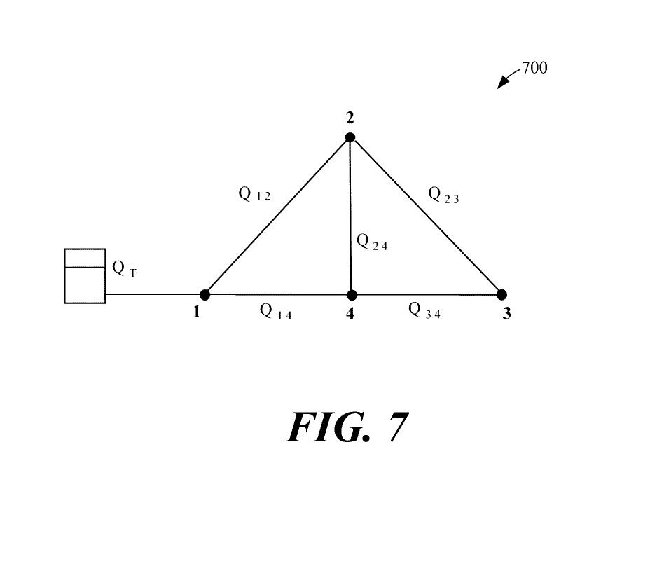

Turning to a relatively simple looped network example, FIG. 7 illustrates an example loop network 700 including six pipes and four nodes. Network layout, pipe, and node details are shown in FIG. 7 and Table 3. The initial hydraulic head of the source tank is 110 m and the elevation of the first node connected to the source tank is 100 m. Thus, the available hydraulic pressure head for delivering water flow to the pipes in the looped network 700 is ten meters.

The analysis of using GGA was programmed using MATLAB. It was compared with EPANET2 for code verification used later for low pressure supply runs. Equation (11a), below, shows the system set of this example where Equation (3) is applied. The result of the run was verified with that from EPANET2. Table 4 shows that the first run was verified with the EPANET2 using the MATLAB code. The run shows that the 10 m pressure head is not enough to cover the water flow to the entire network 700 because node 3 produces a negative result value.

TABLE 3
Network Characterization of Simple Network

| | Start | End | Length | Diameter | | Elevation | Demand |
|---|---|---|---|---|---|---|---|
| Pipe | Node | Node | (m) | (mm) | Node | (m) | (L/s) |
| P-T | 0 | 1 | 10 | 250 | T-1 | 110 | |
| P-1 | 1 | 2 | 707 | 250 | J-1 | 100 | 25 |
| P-2 | 2 | 4 | 500 | 250 | J-2 | 90 | 50 |
| P-3 | 2 | 3 | 707 | 250 | J-3 | 95 | 25 |
| P-4 | 1 | 4 | 500 | 250 | J-4 | 80 | 50 |
| P-5 | 3 | 4 | 500 | 250 | | | |

$$[ \begin{matrix}{K}_{T 1} {Q}_{T}^{n - 1} & 0 & 0 & 0 & 0 & 0 & 1 & 0 & 0 & 0 \\ 0 & {K}_{12} {Q}_{12}^{n - 1} & 0 & 0 & 0 & 0 & 1 & - 1 & 0 & 0 \\ 0 & 0 & {K}_{14} {Q}_{14}^{n - 1} & 0 & 0 & 0 & 1 & 0 & 0 & - 1 \\ 0 & 0 & 0 & {K}_{23} {Q}_{23}^{n - 1} & 0 & 0 & 0 & 1 & - 1 & 0 \\ 0 & 0 & 0 & 0 & {K}_{24} {Q}_{24}^{n - 1} & 0 & 0 & 1 & 0 & - 1 \\ 0 & 0 & 0 & 0 & 0 & {K}_{34} {Q}_{34}^{n - 1} & 0 & 0 & 1 & - 1 \\ 1 & 1 & 1 & 0 & 0 & 0 & 0 & 0 & 0 & 0 \\ 0 & - 1 & 0 & 1 & 1 & 0 & 0 & 0 & 0 & 0 \\ 0 & 0 & 0 & - 1 & 0 & 1 & 0 & 0 & 0 & 0 \\ 0 & 0 & - 1 & 0 & - 1 & - 1 & 0 & 0 & 0 & 0\end{matrix} ] [ \begin{matrix}{Q}_{T} \\ {Q}_{12} \\ {Q}_{14} \\ {Q}_{23} \\ {Q}_{24} \\ {Q}_{34} \\ {H}_{1} \\ {H}_{2} \\ {H}_{3} \\ {H}_{4}\end{matrix} ] = [ \begin{matrix}{H}_{T} \\ 0 \\ 0 \\ 0 \\ 0 \\ 0 \\ {q}_{1} \\ {q}_{2} \\ {q}_{3} \\ {q}_{4}\end{matrix} ] . \qquad ( 11 a )$$

Equation (11b) shows that matrix settings for modifying the system of the boundary conditions for Equation (9) and Equation (10) for the insufficient pressure node 3. As shown in FIG. 7, pipes 2 and 3 are connected to the insufficient pressure node located at node 3. Thus, Equation (9) is modified for pipes 9 and 10 where they appear in the matrix A₁₂, as shown in Equation (11b) below. Also, Equation (10) is applied to node 3 and it appears on the demand sub-matrix to the right side of the matrix. The bold numbers and letters show these modifications in the relevant matrices. As seen in Equation (11b), the elevation of the node is introduced by solving the system where it was not previous solved before.

The Newton Raphson method was used in the first run using the MATLAB code and the results are shown in Table 4. The results show that there are no additional negative pressure nodes that appear on the solution. This means that the flow is satisfied for the other nodes and pipes. However, the demand at node 2 and node 4 may be affected for the insufficient flow in the node 3. For this case, the change in demand needs to be written as follows from Equation (8). From Equation (11c), the change in demand equations are added at the demand of node 2 and node 4.

$$\begin{matrix}[ \begin{matrix}{K}_{T 1} {Q}_{T}^{n - 1} & 0 & 0 & 0 & 0 & 0 & 1 & 0 & 0 & 0 \\ 0 & {K}_{12} {Q}_{12}^{n - 1} & 0 & 0 & 0 & 0 & 1 & - 1 & 0 & 0 \\ 0 & 0 & {K}_{14} {Q}_{14}^{n - 1} & 0 & 0 & 0 & 1 & 0 & 0 & - 1 \\ 0 & 0 & 0 & {K}_{23} {Q}_{23}^{n - 1} & 0 & 0 & 0 & 0 & 1 & 0 \\ 0 & 0 & 0 & 0 & {K}_{24} {Q}_{24}^{n - 1} & 0 & 0 & 1 & 0 & - 1 \\ 0 & 0 & 0 & 0 & 0 & {K}_{34} {Q}_{34}^{n - 1} & 0 & 0 & 1 & 0 \\ 1 & 1 & 1 & 0 & 0 & 0 & 0 & 0 & 0 & 0 \\ 0 & - 1 & 0 & 1 & 1 & 0 & 0 & 0 & 0 & 0 \\ 0 & 0 & 0 & - 1 & 0 & 1 & 0 & 0 & 0 & 0 \\ 0 & 0 & - 1 & 0 & - 1 & - 1 & 0 & 0 & 0 & 0\end{matrix} ] [ \begin{matrix}{Q}_{T} \\ {Q}_{12} \\ {Q}_{14} \\ {Q}_{23} \\ {Q}_{24} \\ {Q}_{34} \\ {H}_{1} \\ {H}_{2} \\ {H}_{3} \\ {H}_{4}\end{matrix} ] = [ \begin{matrix}{H}_{T} \\ 0 \\ 0 \\ {E}_{3} \\ 0 \\ {E}_{3} \\ {q}_{1} \\ {q}_{2} \\ 0 \\ {q}_{4}\end{matrix} ] . & ( 11 b ) \\ [ \begin{matrix}{K}_{T 1} {Q}_{T}^{n - 1} & 0 & 0 & 0 & 0 & 0 & 1 & 0 & 0 & 0 \\ 0 & {K}_{12} {Q}_{12}^{n - 1} & 0 & 0 & 0 & 0 & 1 & - 1 & 0 & 0 \\ 0 & 0 & {K}_{14} {Q}_{14}^{n - 1} & 0 & 0 & 0 & 1 & 0 & 0 & - 1 \\ 0 & 0 & 0 & {K}_{23} {Q}_{23}^{n - 1} & 0 & 0 & 0 & 0 & 1 & 0 \\ 0 & 0 & 0 & 0 & {K}_{24} {Q}_{24}^{n - 1} & 0 & 0 & 1 & 0 & - 1 \\ 0 & 0 & 0 & 0 & 0 & {K}_{34} {Q}_{34}^{n - 1} & 0 & 0 & 1 & 0 \\ 1 & 1 & 1 & 0 & 0 & 0 & 0 & 0 & 0 & 0 \\ 0 & - 1 & 0 & 1 & 1 & 0 & 0 & 0 & 0 & 0 \\ 0 & 0 & 0 & - 1 & 0 & 1 & 0 & 0 & 0 & 0 \\ 0 & 0 & - 1 & 0 & - 1 & - 1 & 0 & 0 & 0 & 0\end{matrix} ] [ \begin{matrix}{Q}_{T} \\ {Q}_{12} \\ {Q}_{14} \\ {Q}_{23} \\ {Q}_{24} \\ {Q}_{34} \\ {H}_{1} \\ {H}_{2} \\ {H}_{3} \\ {H}_{4}\end{matrix} ] = [ \begin{matrix}{H}_{T} \\ 0 \\ 0 \\ {E}_{3} \\ 0 \\ {E}_{3} \\ {q}_{1} \\ {q}_{2} + Δ {q}_{23} \\ 0 \\ {q}_{4} + Δ {q}_{43}\end{matrix} ] . & ( 11 c )\end{matrix}$$

TABLE 4
Program Results of Simple Loop Network
Including Insufficient Flow Condition

| | 1^{st} Run | | 2^{nd} Run | | 3^{rd} Run | |
|---|---|---|---|---|---|---|
| | q | Plγ | q | P/γ | q | P/γ |
| Node | (l/s) | (m) | (l/s) | (m) | (l/s) | (m) |
| T-1 | −150 | 10 | −125 | 10 | −135.668 | 10 |
| J-1 | 25 | 9.851 | 25 | 10 | 25 | 10 |
| J-2 | 50 | 16.045 | 50 | 20 | 54.967 | 20 |
| J-3 | 25 | −4.822 | 0 | 0 | 0 | 0 |
| J-4 | 50 | 25.712 | 50 | 30 | 55.701 | 30 |

The third run results are shown in Table 4. It also shows that the changes in the demand at node 2 and node 4 are not contributing more negative pressure to the system. At this stage, the third run is a stable run and the only insufficient pressure occurs at node 3.

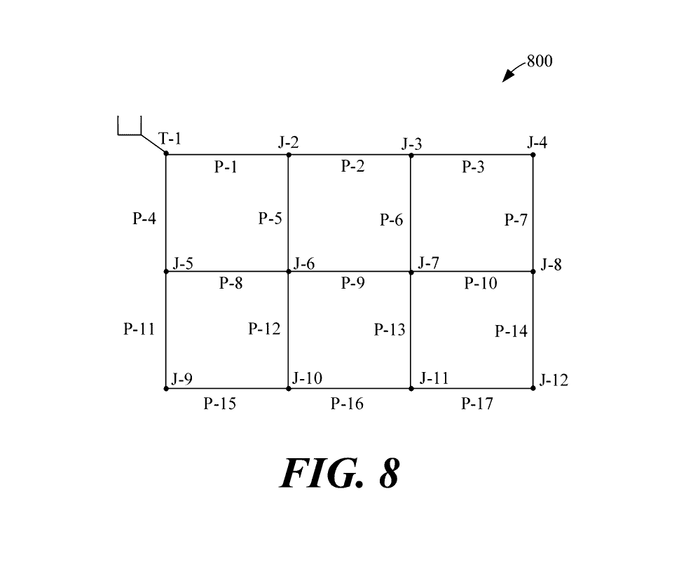

FIG. 8 illustrates another example pipe network 800 and network details. FIG. 8 is an example to compare the proposed and artificial reservoir (AR) methods. The network 800 consists of 12 nodes, 18 pipe elements (one weak pipe is connected to source tank) and a single source tank. All pipes are assumed cast iron with Hazen-Williams roughness coefficient C equal to 130 and all pipe lengths are set to 500 m. Table 5 shows the demand and their network properties, elevation of the nodes, and diameters of all pipes.

TABLE 5
Network Nodes and Pipes Details

| | q | E | | D |
|---|---|---|---|---|
| Node | (L/s) | (m) | Pipe | (mm) |
| T-1 | −410 | 140 | P-T | 250 |
| J-2 | 50 | 90 | P-1 | 250 |
| J-3 | 20 | 80 | P-2 | 200 |
| J-4 | 40 | 85 | P-3 | 150 |
| J-5 | 50 | 85 | P-4 | 250 |
| J-6 | 50 | 90 | P-5 | 200 |
| J-7 | 50 | 85 | P-6 | 150 |
| J-8 | 10 | 90 | P-7 | 100 |
| J-9 | 40 | 85 | P-8 | 200 |
| J-10 | 50 | 80 | P-9 | 150 |
| J-11 | 40 | 90 | P-10 | 100 |
| J-12 | 10 | 100 | P-11 | 200 |
| | | | P-12 | 150 |
| | | | P-13 | 100 |
| | | | P-14 | 100 |
| | | | P-15 | 150 |
| | | | P-16 | 100 |
| | | | P-17 | 100 |

For this example, when the water level at the tank reaches 140 m, the result of the EPANET2 run shows that five nodes are insufficient in pressure. A three-step method was proposed to evaluate the pressure head and the required demand in such cases. Particularly, it was proposed that AR tanks be iteratively simulated at the deficit nodes to relocate the sources in the network 800. The results of the simulation using the AR tanks are compared against the results using the proposed techniques in Table 7.

The process shown in FIG. 4 was also is applied to evaluate the pressure for all nodes and pipes of the network 800. Table 6 presents the run for all steps in the procedure. The result of the first run was the original GGA run, and the run resulted in 5 negative pressures at nodes 4, 7, 8, 11 and 12. The second and third runs show simulation results of all the nodes appearing to be at stable positive pressures. The fourth runs accounts for the unbalanced distribution in water demand applied for the connected nodes to the deficit nodes 11 and 12. As a result, the negative pressure that appears on node 8 is treated with the upcoming negative pressure that appears at node 8. The final results at the fifth run show that all of the nodes reach stable positive pressure flows.

TABLE 6
Program Results at all Run Stages

| | 1^{st} Run | | 2^{nd} Run | | 3^{rd} Run | | 4^{th} Run | | 5^{th} Run | |
|---|---|---|---|---|---|---|---|---|---|---|
| | q | P/γ | q | P/γ | q | P/γ | q | P/γ | q | P/γ |
| Node | (l/s) | (m) | (l/s) | (m) | (l/s) | (m) | (l/s) | (m) | (l/s) | (m) |
| | −410 | 10 | −400 | 10.182 | −360 | 10.150 | −373.593 | 10.160 | −370.977 | 10.158 |
| J-2 | 50 | 28.760 | 50 | 30.714 | 50 | 35.832 | 50 | 33.953 | 50 | 34.313 |
| J-3 | 20 | 15.825 | 20 | 20.475 | 20 | 29.736 | 20 | 25.984 | 20 | 26.344 |
| J-4 | 40 | −12.459 | 40 | −2.780 | 40 | 8.038 | 40 | 3.625 | 44.211 | 0.688 |
| J-5 | 50 | 37.229 | 50 | 38.289 | 50 | 43.099 | 50 | 41.688 | 50 | 41.984 |
| J-6 | 50 | 19.240 | 50 | 21.220 | 50 | 28.840 | 50 | 26.367 | 50 | 27.008 |
| J-7 | 50 | −0.824 | 50 | 4.282 | 50 | 18.666 | 59.503 | 12.625 | 62.676 | 15.250 |
| J-8 | 10 | −22.314 | 10 | −7.297 | 10 | 4.619 | 10 | −0.313 | 0 | 0 |
| J-9 | 40 | 23.588 | 40 | 24.836 | 40 | 32.932 | 40 | 30.789 | 40 | 31.180 |
| J-10 | 50 | 15.020 | 50 | 16.667 | 50 | 31.173 | 54.090 | 27.750 | 54.090 | 28.234 |
| J-11 | 40 | −33.446 | 40 | −31.421 | 0 | 0 | 0 | 0 | 0 | 0 |
| J-12 | 10 | −43.284 | 0 | 0 | 0 | 0 | 0 | 0 | 0 | 0 |

TABLE 7
Result Comparison between using the Artificial
Reservoirs and Proposed Method.

| | |
|---|---|
| Todini 2006 | Proposed method |

| | q | P/γ | q | P/γ |
|---|---|---|---|---|
| Node | (l/s) | (m) | (l/s) | (m) |
| T-1 | −378.5 | 10 | −371.00 | 10.158 |
| J-2 | 50 | 33.41 | 50 | 34.313 |
| J-3 | 20 | 25.95 | 20 | 26.344 |
| J-4 | 40 | 4.77 | 44.21 | 0.688 |
| J-5 | 50 | 35.53 | 50 | 41.984 |
| J-6 | 50 | 30.09 | 50 | 27.008 |
| J-7 | 50 | 12.53 | 62.68 | 15.250 |
| J-8 | 7.32 | 0 | 0 | 0 |
| J-9 | 40 | 28.61 | 40 | 31.180 |
| J-10 | 50 | 23.56 | 54.09 | 28.234 |
| J-11 | 21.18 | −0.02 | 0 | 0 |
| J-12 | 10 | −9.99 | 0 | 0 |

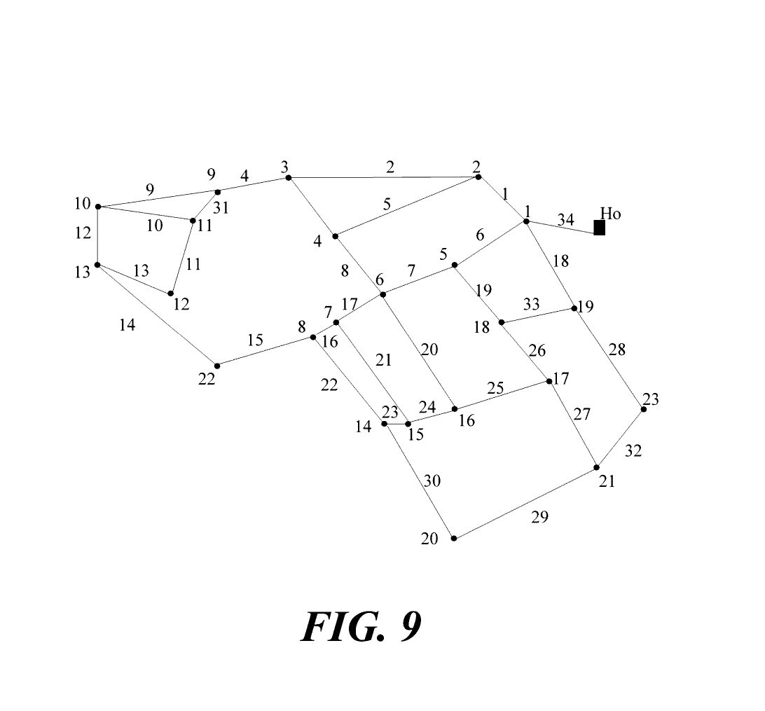

In another case, the Apulian Network, an example of which is shown in FIG. 9, is presented. With the Apulian Network, a hydraulic pressure head at the source tank can be set to 36.4 m, and this supply can create a positive pressure at all of the network nodes. To examine the embodiments described herein, the head at the tank was lowered to 25 m and the head did not cause flow pressure at five nodes (i.e., nodes 12, 13, 20, 21, 23) as shown in Table 8. The insufficient pressure condition is expected in some parts of the network. The process presented in FIG. 4 was used to compensate for change in pressure and the demands at the network node.

Table 8 shows simulation results for a regular run of EPANET2 and another run using the process shown in FIG. 4. Four runs were performed to reach the final solution. The result of the run included locating insufficient nodes at four points (i.e., nodes 12, 13, 20 and 23). However, a minimum head is not assumed as being significant in this example. As observed from Table 8, the total demand at the designed values of the demand in summation is reduced from 254.15 to 245.20 liter per second. This reduction is due to the fact that insufficient pressure occurs. It may be noticed that there is an increase in the amount of demand in some of the adjacent nodes next to the insufficient pressure nodes due to a demand transfer of the local meters to these nodes. This situation can be expected if the demands are located directly from the meter's node as shown in FIG. 2. This example shows the capability of the processes described herein to handle a large network.

TABLE 8
Network Specification and Run Result of Apulian Network at Low Pressure Supply

| | | | | | | | EPANET2 | | Proposed method | |
|---|---|---|---|---|---|---|---|---|---|---|
| | Start | End | Length | Diameter | | Elevation | designed | | Actual | |
| Pipe | node | node | m | m | Node | m | q l/s | P m | q l/s | P m |
| 1 | 1 | 2 | 348.5 | 0.327 | 1 | 6.4 | 10.9 | 15.5042 | 10.863 | 15.8432 |
| 2 | 2 | 3 | 955.7 | 0.29 | 2 | 7 | 17.05 | 13.4213 | 17.034 | 13.9359 |
| 3 | 3 | 4 | 483 | 0.1 | 3 | 6 | 14.9 | 9.8974 | 14.947 | 11.1003 |
| 4 | 3 | 9 | 400.7 | 0.29 | 4 | 8.4 | 14.25 | 5.8696 | 14.28 | 6.588 |
| 5 | 2 | 4 | 791.9 | 0.1 | 5 | 7.4 | 10.1 | 12.1628 | 10.133 | 12.2128 |
| 6 | 1 | 5 | 404.4 | 0.368 | 6 | 9 | 15.3 | 8.7599 | 15.35 | 8.8939 |
| 7 | 5 | 6 | 390.6 | 0.327 | 7 | 9.1 | 9.15 | 7.5845 | 9.114 | 7.7744 |
| 8 | 6 | 4 | 482.3 | 0.1 | 8 | 9.5 | 10.55 | 6.5957 | 10.51 | 6.8233 |
| 9 | 9 | 10 | 934.4 | 0.1 | 9 | 8.4 | 12.2 | 6.4361 | 12.182 | 7.8752 |
| 10 | 11 | 10 | 431.3 | 0.184 | 10 | 10.5 | 14.6 | 1.2891 | 17.0894 | 3.5417 |
| 11 | 11 | 12 | 513.1 | 0.1 | 11 | 9.6 | 9 | 4.8235 | 10.965 | 6.3813 |
| 12 | 10 | 13 | 428.4 | 0.184 | 12 | 11.7 | 7.55 | −1.3596 | 0 | 0 |
| 13 | 12 | 13 | 419 | 0.1 | 13 | 12.3 | 15.2 | −1.3155 | 0 | 0 |
| 14 | 22 | 13 | 1,023.10 | 0.1 | 14 | 10.6 | 13.6 | 4.2028 | 16.3894 | 4.724 |
| 15 | 8 | 22 | 455.1 | 0.164 | 15 | 10.1 | 9.25 | 2.4105 | 9.226 | 2.6032 |
| 16 | 7 | 8 | 182.6 | 0.29 | 16 | 9.5 | 11.2 | 2.7648 | 11.2 | 2.8155 |
| 17 | 6 | 7 | 221.3 | 0.29 | 17 | 10.2 | 11.45 | 3.8175 | 11.469 | 3.4089 |
| 18 | 1 | 19 | 583.9 | 0.164 | 18 | 9.6 | 10.8 | 7.4248 | 10.818 | 6.099 |
| 19 | 5 | 18 | 452 | 0.229 | 19 | 9.1 | 14.7 | 7.9453 | 18.2988 | 16.9559 |
| 20 | 6 | 16 | 794.7 | 0.1 | 20 | 13.9 | 13.35 | −1.7206 | 0 | 0 |
| 21 | 7 | 15 | 717.7 | 0.1 | 21 | 11.1 | 14.65 | −0.0517 | 4.958 | 1.0929 |
| 22 | 8 | 14 | 655.6 | 0.258 | 22 | 11.4 | 12 | 2.7213 | 20.3793 | 2.4593 |
| 23 | 15 | 14 | 165.5 | 0.1 | 23 | 10 | 10.35 | −1.5917 | 0 | 0 |
| 24 | 16 | 15 | 252.1 | 0.1 | 24/tank | 6.4 | | 18.6* | | 18.6* |
| 25 | 17 | 16 | 331.5 | 0.1 | | | | | | |
| 26 | 18 | 17 | 500 | 0.204 | | | | | | |
| 27 | 17 | 21 | 579.9 | 0.164 | | | | | | |
| 28 | 19 | 23 | 842.8 | 0.1 | | | | | | |
| 29 | 21 | 20 | 792.6 | 0.1 | | | | | | |
| 30 | 20 | 14 | 846.3 | 0.184 | | | | | | |
| 31 | 9 | 11 | 164 | 0.258 | | | | | | |
| 32 | 23 | 21 | 427.9 | 0.1 | | | | | | |
| 33 | 19 | 18 | 379.2 | 0.1 | | | | | | |
| 34 | 24 | 1 | 158.2 | 0.368 | | | | | | |

*The pressure at the source tank is estimated based on the elevation of its connected node (node1) rather than the physical elevation of the tank (which is 15 m.)

In some cases, the example water networks shown in FIGS. 6-9 can include any number of water pressure, water flow, elevation, or other sensors at various nodes, pipes, etc. Data obtained from such sensors can be collected over computer networks through a SCADA system, for example, or another data acquisition system. The data can be applied, at least in part, as input data for certain nodes in the processes described with reference to FIGS. 4 and 5 and the other examples provided herein.

The embodiments of the present disclosure describe a modified algorithm to handle the situation when the water network experiences a low pressure supply situation. In low pressure supply situations, the water flow is not expected to be delivered to all parts of the network. The modified algorithm shows the capabilities of being able to identify the deficit pressure zones and simulate the boundary conditions to solve the definite node conditions. In addition, the process was tested for different examples and demonstrates that it can be applied for a large water distribution network. Finally, this algorithm can be programmed and used for a water network situation under different levels of low pressure supplies.

Turning to FIG. 10, an example hardware diagram of a computing device 1000 is illustrated. The computing device 1000 can be used to perform certain aspects of the processes described herein, including the process steps described above with reference to FIGS. 4 and 5. The computing device 1000 is just one example of a computing device that can be used to perform the processes described herein, and other devices can be used. In some cases, a number of computing devices can work together in a network of devices to perform the processes.

As shown in FIG. 10, the computer 1000 includes a processor 1010, a Random Access Memory (RAM) 1020, a Read Only Memory (ROM) 1030, a memory device 1040, a network interface 1050, and an Input Output (I/O) interface 1060. The elements of the computer 1000 are communicatively coupled to each other via a local interface 1002.

The processor 1010 can comprise any general purpose arithmetic processor, Application Specific Integrated Circuit (“ASIC”), or related processing device. The RAM and ROM 1020 and 1030 comprise any non-transitory random access or read only memory device that can store computer-readable instructions to be executed by the processor 1010. The memory device 1040 can store computer-readable instructions thereon that, when executed by the processor 1010, direct the processor 1010 to execute various aspects of the present invention described herein. When the processor 1010 comprises an ASIC, the processes described herein may be executed by the ASIC according to an embedded circuitry design of the ASIC, by firmware of the ASIC, or both an embedded circuitry design and firmware of the ASIC.

The memory device 1040 can comprise a non-transitory storage device or medium, such as an optical disc, a magnetic disc, a semiconductor memory (i.e., a semiconductor, floating gate, or similar flash based memory), a magnetic tape memory, a removable memory, combinations thereof, or any other memory device for storing computer-readable instructions. The network interface 1050 comprises hardware interfaces to communicate over data over computer networks. As described above, the example water networks shown in FIGS. 6-9 can include any number of water pressure, water flow, elevation, or other sensors at various nodes, pipes, etc. Data obtained from such sensors can be collected over computer networks through a SCADA system, for example, or another data acquisition system. The data can be gathered over the network interface 1050 for processing as input data for the evaluation of certain nodes in the processes described with reference to FIGS. 4 and 5, for example, among other examples provided herein.

The I/O interface 1060 comprises device input and output interfaces such as keyboard, pointing device, display, communication, and other interfaces. The local interface 1002 electrically and communicatively couples the processor 1010, the RAM 1020, the ROM 1030, the memory device 1040, the network interface 1050, and the I/O interface 1060, so that data and instructions may be communicated among them.

In operation, the processor 1010 is configured to retrieve computer-readable instructions stored on the memory device 1040, the RAM 1020, the ROM 1030, or another storage means, and copy the computer-readable instructions to the RAM 1020 or the ROM 1030 for execution, for example. The processor 1010 is further configured to execute the computer-readable instructions to implement various aspects of the embodiments described herein. For example, the processor 1010 can be adapted and configured to execute the processes described above with reference to FIGS. 4 and 5 based on a set of computer-readable instructions stored in the memory device 1040, the RAM 1020, the ROM 1030, or another storage means.

Although embodiments have been described herein in detail, the descriptions are provided by way of example. The features of the embodiments described herein are representative and, in alternative embodiments, certain features and elements may be added or omitted. Additionally, modifications to aspects of the embodiments described herein may be made by those skilled in the art without departing from the spirit and scope of the present invention defined in the following claims, the scope of which are to be accorded the broadest interpretation so as to encompass modifications and equivalent structures.

Therefore, at least the following is claimed:

1. A method for hydraulic distribution network modeling, comprising:
evaluating, with a computing device, a water distribution model to generate a water pressure head measurement for a node in a water distribution network;
determining whether the water pressure head measurement for the node is less than a minimum pressure head value;
in response to a determination that the water pressure head measurement for the node is less than the minimum pressure head value, setting, with the computing device, node parameters associated with the node to zero pressure and zero demand and setting a pipe parameter associated with a pipe connected to the node to zero flow; and
evaluating, with the computing device, the water distribution model again to generate another water pressure head measurement for the node based on the zero pressure and zero demand node parameters and the zero flow pipe parameter.

2. The method according to claim 1, further comprising:
after evaluating the water distribution model again, determining whether the water pressure head measurement for the node is greater than the minimum pressure head value; and
in response to a determination that the water pressure head measurement for the node is greater than the minimum pressure head value, adjusting, with the computing device, demand associated with the node.

3. The method according to claim 1, further comprising evaluating, with the computing device, the water distribution model again after adjusting the demand associated with the node.

4. The method according to claim 1, wherein:
evaluating the water distribution model comprises evaluating, with the computing device, the water distribution model to generate a water pressure head measurement for a plurality of nodes in the water distribution network; and
the process further comprises identifying a greatest negative pressure node among the plurality of nodes.

5. The method according to claim 4, wherein setting the node parameters and the pipe parameter comprises setting, with the computing device, node parameters associated with the greatest negative pressure node to zero pressure and zero demand and setting a pipe parameter associated with a pipe connected to the greatest negative pressure node to zero flow.

6. The method according to claim 1, wherein evaluating the water distribution model comprises evaluating the water distribution model using EPANET.

7. The method according to claim 1, wherein evaluating the water distribution model comprises evaluating the water distribution model using EPANET and the Global Gradient Algorithm.

8. A system for hydraulic distribution network modeling, comprising:
a memory device to store computer-readable instructions thereon; and
a computing device configured, through the execution of the computer-readable instructions, to:
evaluate a water distribution model to generate a water pressure head measurement for a node in a water distribution network;
determine whether the water pressure head measurement for the node is less than a minimum pressure head value; and
in response to a determination that the water pressure head measurement for the node is less than the minimum pressure head value, set node parameters associated with the node to zero pressure and zero demand and setting a pipe parameter associated with a pipe connected to the node to zero flow.

9. The system according to claim 8, wherein the computing device is further configured to evaluate the water distribution model again to generate another water pressure head measurement for the node based on the zero pressure and zero demand node parameters and the zero flow pipe parameter.

10. The system according to claim 9, wherein the computing device is further configured, after evaluating the water distribution model again, to:
determine whether the water pressure head measurement for the node is greater than the minimum pressure head value; and
in response to a determination that the water pressure head measurement for the node is greater than the minimum pressure head value, adjust demand associated with the node.

11. The system according to claim 10, wherein the computing device is further configured to evaluate the water distribution model again based on the adjusted demand associated with the node.

12. The system according to claim 8, wherein the computing device is further configured to:
generate a water pressure head measurement for a plurality of nodes in the water distribution network; and
identify a greatest negative pressure node among the plurality of nodes.

13. The system according to claim 12, wherein the computing device is further configured to set node parameters associated with the greatest negative pressure node to zero pressure and zero demand and set a pipe parameter associated with a pipe connected to the greatest negative pressure node to zero flow.

14. The system according to claim 12, wherein the computing device is further configured to evaluate the water distribution model using EPANET and the Global Gradient Algorithm.

15. A method for hydraulic distribution network modeling, comprising:
evaluating, with a computing device, a water distribution model to generate a water pressure head measurement for a node in a water distribution network;
determining whether the water pressure head measurement for the node is less than a minimum pressure head value; and
in response to a determination that the water pressure head measurement for the node is less than the minimum pressure head value, setting, with the computing device, at least one parameter associated with the node to zero.

16. The method according to claim 15, further comprising evaluating, with the computing device, the water distribution model again to generate another water pressure head measurement for the node based on the at least one parameter set to zero.

17. The method according to claim 16, further comprising:
after evaluating the water distribution model again, determining whether the water pressure head measurement for the node is greater than the minimum pressure head value; and
in response to a determination that the water pressure head measurement for the node is greater than the minimum pressure head value, adjusting, with the computing device, demand associated with the node.

18. The method according to claim 17, further comprising evaluating, with the computing device, the water distribution model again after adjusting the demand associated with the node.

19. The method according to claim 15, wherein:
evaluating the water distribution model comprises evaluating, with the computing device, the water distribution model to generate a water pressure head measurement for a plurality of nodes in the water distribution network; and
the process further comprises identifying a greatest negative pressure node among the plurality of nodes.

20. The method according to claim 19, wherein setting the at least one parameter comprises setting, with the computing device, at least one parameter associated with the greatest negative pressure node to zero.
